(19) United States
(12) Patent Application Publication
(10) Pub. No.: US 2008/0140520 A1
(43) Pub. Date: Jun. 12, 2008

(54) SYSTEMS AND METHODS FOR PROVIDING COUPONS

(75) Inventors: ADAM HYDER, LOS ALTOS, CA (US); CHYR-CHONG (JOSEPH) TING, SAN JOSE, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/609,158

(22) Filed: Dec. 11, 2006

(51) Int. Cl. G06Q 30/00

(52) U.S. Cl. 705/14

(57) ABSTRACT

Methods and systems of distributing coupons to a consumer are disclosed herein. A geographical location of the consumer is received. A set of merchants located within a predetermined distance from the geographical location is identified so that the merchants in the set of merchants are located within the vicinity of the consumer. A coupon that can be redeemed for purchase of merchandise of one of the set of merchants is further identified. The coupon can be delivered to an electronic wallet of the consumer. The electronic wallet can be accessible by the consumer through a data network such that the consumer can apply the coupon to the purchase of the merchandise from the merchant.

### BACKGROUND

1. Field

The present disclosure relates to advertisement. In particular, it relates to systems and methods of providing coupons to consumers.

2. General Background

Internet advertising has become a prime direct marketing channel for companies selling goods and services. Furthermore, Internet advertising offers the unprecedented opportunity to tailor individualized ads to online consumers because online consumers generate behavioral and demographic data that provide insight into their goals and preferences. Consumer behavior can be established by tracking consumer activities online, storing consumer preferences, etc. In addition, as portable computing devices become more pervasive, consumer access to the Internet through portable computer devices also increase.

### SUMMARY

In one aspect, there is a method of distributing coupons to a consumer. A geographical location of the consumer is received. A set of merchants located within a predetermined distance from the geographical location is identified so that the merchants in the set of merchants are located within the vicinity of the consumer. A coupon that can be redeemed for purchase of merchandise of one of the set of merchants is further identified. The coupon can be delivered to an electronic wallet of the consumer. The electronic wallet can be accessible by the consumer through a data network such that the consumer can apply the coupon to the purchase of the merchandise from the merchant.

In another aspect, further comprising submitting an alert indicator to a consumer computing device once the coupon is delivered to the consumer.

Furthermore, the electronic wallet can reside on a remote location on the data network. In addition, the geographical location can be a longitude and latitude calculated by a ground positioning system.

In another aspect, the coupon can be applied towards the purchase the merchandise from the one of the set of merchants.

In another aspect, the consumer is permitted to access the coupon in the electronic wallet over the computer network in order to redeem the coupon, the consumer accessing the coupon using a consumer computing device that communicates over the computer network with the service provider. In a further aspect, the consumer can be permitted to view the coupon in the electronic wallet in order to redeem the coupon.

In another aspect, a redemption request is received from the merchant upon the consumer providing the coupon to the merchant. In yet another aspect, the coupon can be validated upon receiving the redemption request. Furthermore, coupons can be searched according to consumer preferences.

In another aspect, there is a system of distributing coupons to a consumer. The system can comprise a search engine and a coupon delivery module. The search engine identifies a set of merchants located within a predetermined distance from a geographical location so that the merchants in the set of merchants are located within the vicinity of the consumer. The search engine can be configured to identify a coupon that can be redeemed for purchase of merchandise of one of the set of merchants. The coupon delivery module delivers the coupon to an electronic wallet of the consumer. The electronic wallet can be accessible by the consumer through a data network such that the consumer can apply the coupon to the purchase of the merchandise from the merchant.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a component diagram of a system for providing coupons to a consumer according to one embodiment.

FIG. 2 depicts a component diagram of a computing device according to one embodiment.

FIG. 3 depicts a flow diagram of a process for providing coupons to a consumer according to one embodiment.

FIG. 4 depicts an exemplary user interface of an electronic wallet of a consumer according to one embodiment.

FIG. 5 depicts an exemplary user interface of a coupon stored in an electronic wallet of a consumer according to one embodiment.

### DETAILED DESCRIPTION

Various methods and systems for coupon delivery are disclosed. A service provider can host an electronic wallet service. The service provider can receive the geographical position of the consumer and deliver coupons or advertisements of merchants that are in the vicinity of the consumer. Merchants can be business entities that register or affiliate with the service provider in order to deliver coupons through the service provide. In addition, merchants can verify coupons through the service provider, and receive feedback of coupon redemption, sales, and any transaction data in general. In one embodiment, coupons can delivered in an electronic format to a portable device of consumers. Merchants can communicate via a computer network with the service provider to verify the validity of the coupon, remove the coupon from the electronic wallet of the consumer and finalize the transaction.

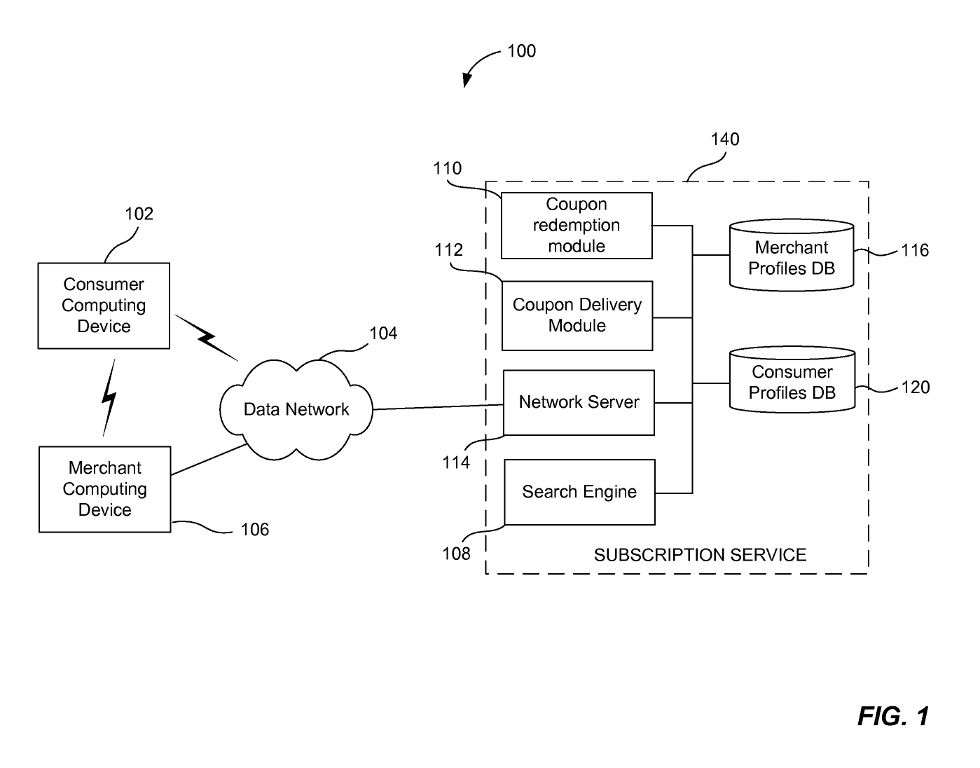

FIG. 1 depicts a component diagram of a system 100 for providing coupons to a consumer according to one embodiment. A service provider 140 can host one or more services utilized by a consumer. As such, the service provider 140 can be a business entity that owns and operates a computer infrastructure connected to a data network 104 in order to provide a plurality of services such as electronic wallet services, Internet transactions such as purchases, online ordering, etc. In one embodiment, the data network can be the Internet. In another embodiment, the data network can be an intranet. The subscription service 104 can include a network server 114 that provides one or more consumer interfacing modules that allow a consumer to access the services of the subscription service 140 through the data network 104. As it is well known in the art, a website that can be rendered in a web browser can be utilized as a user interface.

In one embodiment, a consumer accesses one or more user interfaces provided by the subscription service 140 through a consumer computing device 102. As such, the consumer computing device 102 can communicate via the other data network 104 with one or more computing modules and/or services that are part of the computer infrastructure managed by the service provider 140.

In another embodiment, the consumer computing device 102 can communicate through the data network 104 via any client-side application installed on the consumer computing device. Such application can be configured to communicate in a predetermined protocol with the network server 114. As such, the consumer computing device 102 can communicate, for example, using wireless protocols such as cellular wireless protocols (e.g., CDMA, TDMA, and GSM), WiFi, Bluetooth, or any other wireless protocol that can permit the transfer of data through the data network 104. The consumer computing device 102 can be a cell phone, a persona data assistant, a laptop, a Smart Phone, or any other handheld or portable device configured to communicate wirelessly with data network 104.

In one embodiment, the consumer computing device 102 can be configured with a web browser that allows the consumer computing device 102 to send data to and receive data from the network server 114. The consumer computing device 102 communicates with the network server 114 to render web pages received from the network server 114. In addition, the consumer computing device 102 can be configured to transmit consumer input to the data network 104 directed to the network server 114.

In a further embodiment, the consumer computing device 102 can be configured to determine the geographical location of the consumer computing device 102 and therefore the geographical location of the consumer. In one example, the consumer computing device 102 can be configured with a GPS receiver (not shown) that can receive coordinates of the geoposition of the consumer computing device 102 and further can be configured with logic to determine the location of the consumer computing device 102. In another example, the consumer computing device 102 can be configured to determine its geographical location based on an IP address of the consumer computing device 102. As it is known in the art, IP addresses can be mapped to a geographical area according to one or more attributes of the IP address.

In another embodiment, the consumer computing device 102 can further be configured with logic to receive input commands from the consumer to view advertisements, coupons or other material received in association with one or more merchants. For example, the consumer computing device 102 can be configured with a transmitter to send data to another computing device such as a merchant computing device 106. The wireless transmission from the consumer computing device 102 to the merchant computing device 106 can be using wireless protocols now known or to become known. For example, wireless protocols such as Bluetooth or infrared data transmission can be used. The consumer computing device 102 can communicate with the merchant computing device 106 in order to receive promotional materials such as coupons, redeem a coupon, perform a purchase transaction, etc.

As the consumer interacts with the subscription service 140 using the consumer computing device 102, the network's server 114 can also be configured to track consumer activity and record such consumer activity in one or more data repositories. For example, the network server 114 can report consumer activity such as web requests, search requests, search results, listings saved or printed or e-mailed, listings used, bid, bought, applied for, viewed, discarded, requested media, uploaded media, redeemed coupons, advertisement or promotional material received, types of purchases performed at online stores, articles purchased at online stores, etc. Consumer activity can be stored in a consumer profiles database 120 in relation to a consumer profile. In addition to implicit data collected from consumer behavior online, the network server 114 can also collect explicit data provided by the consumer. For example, the network server 114 can report consumer demographic information entered by the consumer, such as age, gender, date of birth, name, address, etc. at a generic data repository such as the consumer profiles database 120.

In another embodiment, a merchant can connect through the data network 104 using a merchant computing device 106 to the subscription service 140. Thus, the merchant computing device 106 can be configured with a client side software application to interact with the network server 114 for performing multiple operations. For example, the merchant computing device 106 can be configured to submit a request to the subscription service 140 in order to verify the validity of a coupon that the merchant computing device 106 has received from the consumer computing device 102. In another example, the merchant computing device 106 can be configured to submit a request to redeem a coupon that the merchant computing device 106 has received from the consumer computing device 102. In addition, the merchant computing device 106 can also be configured to receive coupons from a consumer computing device 102. For example, the client software installed on the merchant computing device 106 can be configured with an infrared barcode reading module (not shown) or other input reading software that can allow the client software to recognize a coupon. The coupon can be recognized based on a predetermined code, symbol, image or any other coupon representation.

In a further embodiment, the client software installed on the merchant computing device 106 can for example be a web browser. As such, a browser installed on the merchant computing device 106 can be utilized to present various user interface mechanisms that can allow to communicate with a portal of the subscription service 140 such as network server 114. In addition, the browser can further be utilized to display user interfaces for verification of coupons or promotional materials of a merchant, uploading of coupons and promotional materials of the merchant, as well as submission of approved coupons and discounts provided to a consumer. In another example, the client software installed on the merchant computing device 106 can be any other client site application installed on the merchant computing device 106.

In one embodiment, coupons and promotional material provided to a consumer can be delivered through a coupon delivery module 112. For example, the coupon delivery module 112 can be configured to receive the geographical location of a consumer. The geographical location can be communicated using an address, coordinates (latitude and longitude), or other geographical indicator that can indicate the address of the consumer. Using the geographical location, the coupon delivery module 112 can request a search engine 108 to identify one or more merchants that are located within a predetermined distance from the location of the consumer. In one embodiment, the predetermined distance can be a distance that is variable depending upon the location of the consumer. For example, if the consumer is located within a downtown area or a shopping mall area, then the predetermined distance can be shortened such that the merchants returned as part of the search are close to the consumer. If the consumer is located in a residential area, the predetermined distance can be longer so as to cover a greater area and include more merchants.

In a further embodiment, the coupon delivery module 112 can further request a search engine 108 that searches for coupons provided by merchants located within a predetermined distance from the location of the consumer. As such, the search engine 108 can have access to one or more merchant profile databases 116 which store merchant information and associated promotional advertisement coupons, etc. Once the search engine determines a set of merchants that are closely located to the consumer and a set of coupons that are relevant to the consumer, the search engine 108 can return search results to the coupon delivery module 112 in order to transmit one or more coupons to the consumer.

In a further embodiment, the search engine 108 can also be configured to search the consumer profile in the consumer profiles database 120 in order to determine consumer preferences. For example, previous customer interactions and consumer behavior as collected by the network server 114 can be utilized to deliver coupons. Consumer profiles in the consumer profiles database 120 can provide consumer preference information so as to provide best matching advertisements and coupons. For example, if the consumer has a corresponding consumer profile that indicates that the consumer enjoys Japanese food, the search engine 108 can search for Japanese restaurants in the merchant profiles database 116. A set of Japanese restaurants within the customer proximity may be returned as part of the search. Further, the search engine 108 can also search for coupons for one of the Japanese restaurants. As previously mentioned, once the search results are produced, the search engine 108 can then communicate the search results to the coupon delivery module 112 for communication of coupons or promotional material to the consumer. Therefore, the coupon delivery module 112 can be configured to transmit a communication to the consumer computing device 102 that a coupon is available.

In another embodiment, the coupon delivery module 112 further stores such coupon or promotional material in the consumer profiles database 120. The consumer profile stored in the consumer profiles database 120 can include or be associated with an electronic wallet. The electronic wallet in turn includes payment information such as credit card information, online payment information such as Pay Pal, Money Bookers, coupons and promotional materials received from the coupon delivery module 112, etc. Furthermore, in another embodiment, the consumer can access the consumer profile and view one or more coupons or promotional material stored in the electronic wallet of the consumer. Based on a consumer command, the consumer can request to view, redeem, or verify, one or more coupons stored in the electronic wallet and further to receive the coupons at the consumer computing device 102. As such, the coupon delivery module 112 can further be configured with logic to transmit the coupons or other promotional materials to the consumer computing device 102 for presenting such promotional material or advertisement to the consumer.

In one embodiment, the consumer receives the coupon or advertisement at the time in which the consumer is in the vicinity of a place of business of the merchant. As the consumer approaches the vicinity of the place of business of the merchant, consumer computing device 102 can be receive a coupon for a promotion or discount offered by the merchant. Thus, the user can utilize the consumer computing device 102 to redeem the promotion or coupon received. Alternatively, the consumer can save such coupons in the electronic wallet of the consumer for later redemption. Therefore, the coupons stored in the electronic wallet of the consumer can be utilized at any time after the coupon has been delivered to the electronic wallet of the consumer.

In another embodiment, the consumer receives the coupon or advertisement at any other time and not necessarily when the consumer is in the vicinity of the merchant to which the coupon applies.

In yet another embodiment, the customer can select a coupon displayed on an Internet webpage to be added to the customer's wallet. Therefore, as the customer browses web pages of the service provider 140, or any other web pages, the customer can select participant coupons. Participant coupons can be provided such that the displayed coupon is associated with logic that permits adding the coupon to the electronic wallet of the consumer. In one example, the coupon displayed on a webpage can include an image of a pair of scissors to “clip” the coupon and add the coupon to the electronic wallet. Accordingly, the coupon delivery module 112 can be configured to receive a message or other indication of a coupon to be added to the electronic wallet. The coupon delivery module 112 can then deliver or add the coupon to the electronic wallet of the customer.

In yet another embodiment, the customer can obtain the coupon from a newspaper, a magazine, etc., and use information related to the coupon to add an electronic coupon to the electronic wallet. In one example, the consumer can use a code printed on the physical coupon. The consumer can then enter the code on a user interface of the electronic wallet to add the coupon. As such, the coupon delivery module 112 can be configured to receive the code and deliver the coupon to the wallet of the consumer.

In addition, once the customer receives a coupon, an alert can be provided to the customer. For example, an email message, an instant message, or any other form of customer alerts now known or to become known can be used.

The consumer can request the redemption of a coupon in one or more ways. For example, the consumer can access the consumer computing device 102 and utilize the user interface provided by the subscription service 140 to view the available coupons. The consumer can then select a desired coupon for redemption and submit the redemption request to the subscription service 140. Such redemption request can be received at the coupon redemption module 110 which can be configured with logic to process such request. For example, the coupon redemption module 110 can be configured to verify the validity of the coupon.

In another embodiment, a consumer computing device 102 can be configured to submit the redemption request to the merchant either wirelessly or via any other communication medium to the merchant computing device 106. In turn, the merchant computing device 106 can make a request to the subscription service 140 for redemption of the consumer's coupon.

In any event, the coupon redemption module 110 can utilize logic to access the merchant profiles database 116 to verify the identity of the merchant, available offers and previous offers of the merchant. In addition, the coupon redemption module 110 can also access the consumer profiles database 120 to retrieve the consumer profile of the consumer who is redeeming the coupon. The coupon redemption module 110 can then be configured with logic to verify that the electronic wallet of the consumer includes the coupon that the consumer is claiming to have received and own. Upon the coupon redemption module 110 verifying the validity of the coupon, the coupon redemption module 110 can transmit an indication to the merchant computing device 106 that the coupon is valid.

In another example, if the consumer computing device 102 made the request, the coupon redemption module 110 can further submit an indication to the consumer computing device 102 that the coupon is valid. Such indication can include a key, or data message that can be used by the consumer computing device 102 or the merchant computing device 106 in order to finalize the transaction. In a further embodiment, upon receiving a redemption request, the coupon redemption module 110 can be configured with logic to remove the coupon from the electronic wallet of the consumer. As such, the coupon redemption module 110 would access the consumer profiles database 120 in which the electronic wallet information of each consumer is stored and delete the coupon corresponding to the redemption request.

In another embodiment, the coupon redemption module 110 can further be configured to provide redemption information to the merchant. As such, the redemption information can include transaction information, price of the purchased good or service, quantity of the order, point of sale, and any other information regarding the consumer that can be public and made available to merchants. Such information can be, for example, stored in association with a merchant profile in the merchant profiles database 116. In one example, if the coupons are store coupons and correspond to coupons that have been issued by the merchant, then the merchant can receive such feedback of consumption and sales in the merchant profile. As such, a merchant who wishes to access sale information, coupon redemption, coupons issued, location of redemptions, etc., can access the merchant profile and view such information.

In one example, where the merchant is a reseller, and the coupons were originally issued by for example a manufacturer, the data collected regarding the transactions, coupon redemption, sales, and any other transactional information can be stored and later submitted to the manufacturers either upon request or automatically. In one embodiment, this information can be utilized by manufacturers to give a percentage of profits back to the resellers in addition to the original revenue obtained by the resellers for sales produced through coupons and other promotional materials.

In another embodiment, the coupon redemption module 110 can further be configured to store and record data associated with purchase behavior of the consumer. This data is not necessarily provided to the merchant, but is stored in the consumer profile for later processing of consumer preferences. For example, if multiple coupons for different types of food are stored in the consumer electronic wallet and the majority of the redeemed coupons are for Japanese restaurants, then the consumer profile can be updated to reflect consumer preference for Japanese food. As such, the consumer profile can continue to be refined and customized. Future deliveries of coupons can benefit from better personalized profiles.

In yet another embodiment, the coupon redemption module 110 can include logic to work with purchase and payment modules (not shown) that are utilized to finalize a sale or transaction between the consumer and the merchant. In a further embodiment, the subscription service 140 can be a merchant itself and provide goods or services that the consumer may purchase. As such, the subscription service 140 can further deliver and/or redeem coupons for services or goods that are sold or leased by the subscription service 140.

In one embodiment, the consumer can redeem the coupon by printing a coupon in the electronic wallet. Once the merchant receives the printed coupon, the merchant can submit the coupon over the computer network 104 to the service provider 140. Once the coupon redemption module 110 at the service provider 140 receives the redemption request, the coupon is verified for validity, redeemed, and removed from the electronic wallet.

While various databases have described herein, one skilled in the art will recognize that each of the aforementioned databases can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

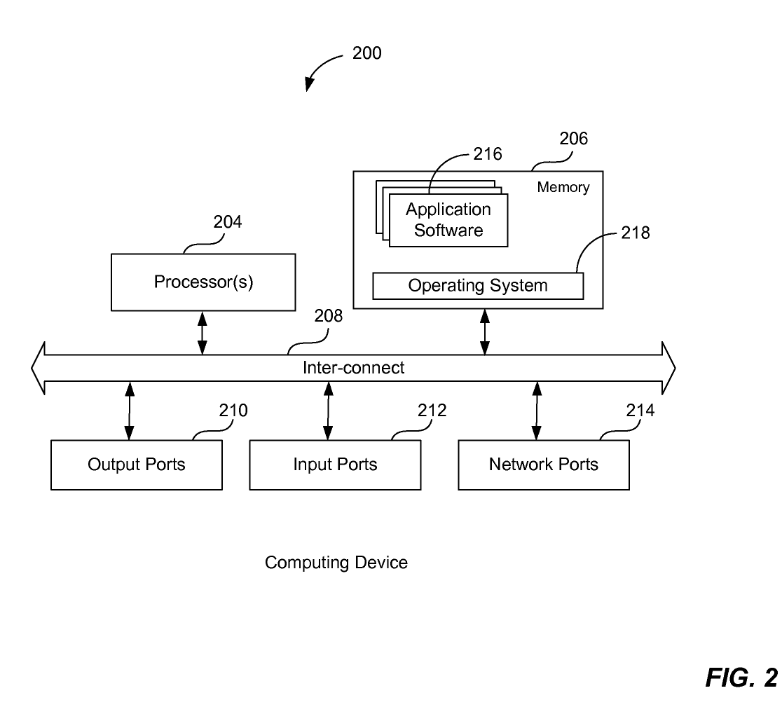

FIG. 2 depicts a component diagram of a computing device according to one embodiment. The computing device 200 can be utilized to implement one or more computing devices, computer processes, or software modules described herein. In one example, the computing device 200 can be utilized to process calculations, execute instructions, receive and transmit digital signals, as required by the consumer computing device 102. The computing device 200 can be utilized to process calculations, execute instructions, receive and transmit digital signals and/or data as required by the coupon redemption module 110, coupon deliver module 112, network server 114, and/or the search engine 108.

The computing device 200 can be any general or special purpose computer now known or to become known capable of performing the steps and/or performing the functions described herein, either in software, hardware, firmware, or a combination thereof.

The computing device 200 includes an inter-connect 208 (e.g., bus and system core logic), which interconnects a microprocessor(s) 204 and memory 206. The inter-connect 208 interconnects the microprocessor(s) 204 and the memory 206 together. Furthermore, the interconnect 208 interconnects the microprocessor 204 and the memory 206 to peripheral devices such input ports 212 and output ports 210. Input ports 212 and output ports 210 can communicate with I/O devices such as mice, keyboards, modems, network interfaces, printers, scanners, video cameras and other devices. In addition, the output port 210 can further communicate with the display 104.

Furthermore, the interconnect 208 may include one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. The inter-connect 208 can also include a network connection 214.

The memory 206 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 206 or obtained through input ports 212 and output ports 210.

In general, routines executed to implement one or more embodiments may be implemented as part of an operating system 218 or a specific application, component, program, object, module or sequence of instructions referred to as application software 216. The application software 216 typically can comprises one or more instruction sets that can be executed by the microprocessor 204 to perform operations necessary to execute elements involving the various aspects of the methods and systems as described herein. For example, the application software 216 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

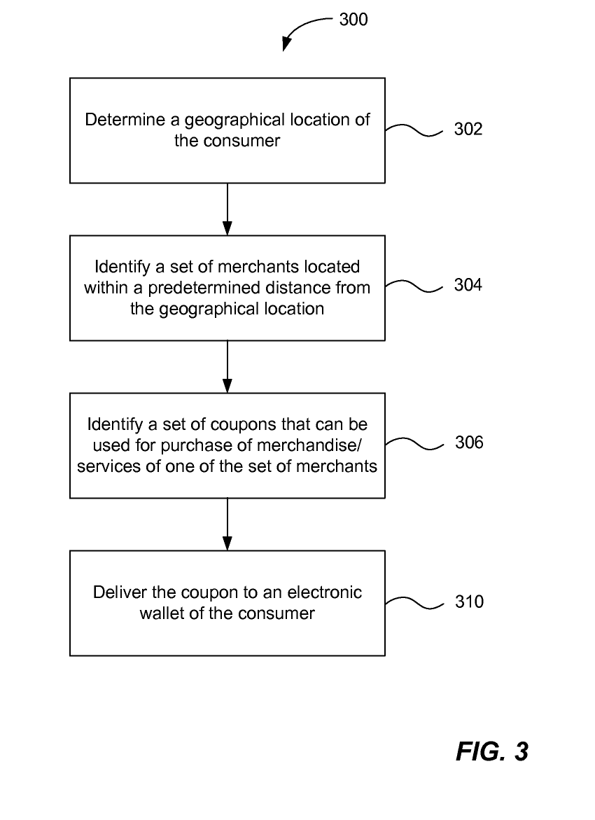

FIG. 3 depicts a flow diagram of a process for providing coupons to a consumer according to one embodiment. At process block 302, the geographical location of the consumer is determined. As previously mentioned, the geographic location of the consumer can be determined by the consumer computing device 102 utilizing GPS data and mapping the GPS data to geolocation data (e.g., a city layout). The geographical location can then later be used to determine merchants that are in proximity to the consumer. Process 300 continues at process block 304.

At process block 304, a set of merchants located within a predetermined distance from the geographical location is identified. A set of merchants can be identified from a merchant profiles database 116. The set of merchants can be compared to the geographical location and determined to have a specific location to the geographical location of the consumer. As such, those merchants in the merchant profiles database 116 that are located within a predetermined distance from the geographic location can be identified. Process 300 continues at process block 306.

At process block 306, a set of coupons is identified. The set of coupons can be used for purchase of merchandise or services from one of the set of merchants. Thus, a coupon database or other form of coupon repository can be stored within the merchant profiles database 116 such that various coupons are associated with each of the merchants in the merchant database 116. The set of coupons identified can additionally be filtered based on the consumer profile preferences. For example, a consumer may have an associated profile in which preferences of the consumer indicate that the consumer has a predilection for Japanese food. In one implementation, such preferences can further be utilized to filter coupons and provide a more focused, personalized, and narrow set of coupons to the consumer. Process 300 continues at process block 310.

At process block 310, the coupon is delivered to the electronic wallet of the consumer. In one example, the electronic wallet of the consumer resides within a consumer profile that in turn is stored in a consumer profiles database 120. In other examples, consumer electronic information and electronic wallet information can be stored in a separate database.

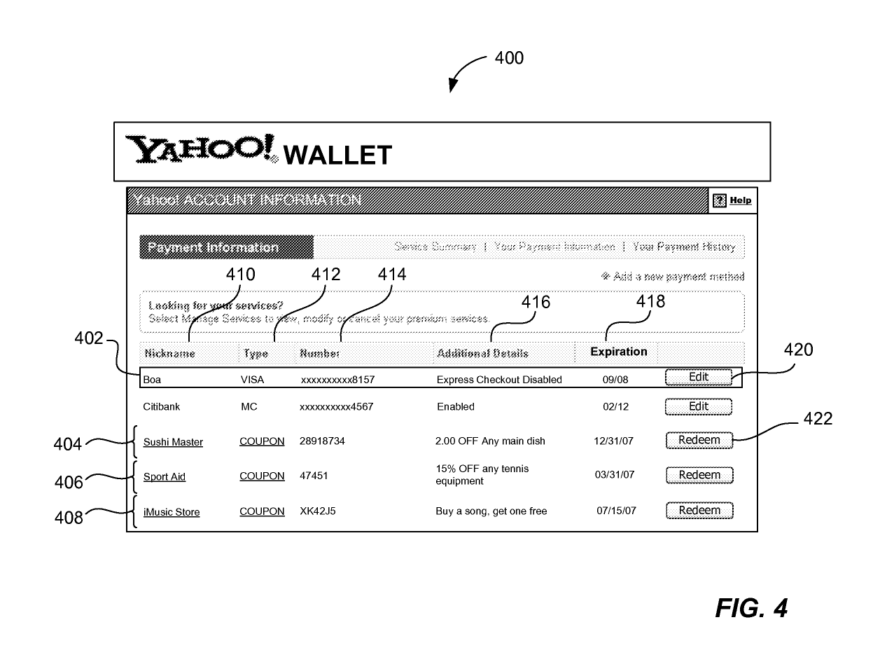

FIG. 4 depicts an exemplary user interface of an electronic wallet of a consumer according to one embodiment. User interface 400 allows a user to interact with the wallet of the user. In one embodiment, the consumer accesses his wallet by logging to an Internet account using authentication methods such as a username and password, etc.

User interface 400 provides a listing of various payment information methods that a consumer can utilize to pay a merchant for goods or services obtained from the merchant. The listings can include credit cards, online banking accounts, regular banking accounts, savings accounts, checking accounts, money market accounts, coupons, etc. These various payment methods can be used by the consumer to pay for goods or services obtained from the consumer. Coupons in the electronic wallet of the consumer can be utilized by the consumer to partially pay for goods, or apply towards the purchase of goods or services. User interface 400 can further illustrate that there are various payment information methods having various attributes. For example, they can include nickname type number details, expiration dates, etc. For example, a nickname column 410 can be utilized to allow the consumer to enter a nickname for the payment method. In addition, a type column 412 can be utilized to display the type of payment method. For example, for a credit card payment method 402, the type can be “Visa®.” Other types for credit cards can be “MasterCard®,” “American Express®”, “Diner's Club®”, etc. In addition, another type of payment information can be for example a coupon. Furthermore, a column 414 for the number can include the number of the credit card or the number of the coupon or bank account information. Furthermore, payment information can also include details and therefore a details column 416 can also be displayed as part of user interface 400. For example, the details at column 416 can include whether or not a credit card has been enabled for express checkout, disabled, etc. As shown in user interface 400, the additional details for coupon 404 can include information about the type of discount or deal that the coupon offers. For example, for coupon 404, $2.00 off any main dish is offered. For coupon 406, 15% off of any tennis equipment is offered. Furthermore, for coupon 408, a promotion to “buy a song, get one free” is offered.

In addition, an expiration date column can also be displayed as part of user interface 400. For example, the expiration date of a credit card can be displayed. In the case of a coupon, an expiration date of the coupon can be displayed to allow the consumer to view the last day in which the consumer can redeem the coupon. Additional user interface mechanisms can be utilized in association with each of the payment methods. For example, an edit button can be utilized in association with credit card 402 in order to edit the credit card information. In another example, a redeem button 422 can be provided in association with coupon 404 to allow a consumer to redeem a coupon stored in the wallet of the consumer.

As previously mentioned, the wallet items and account information illustrated in user interface 400 are accessible through one or more user interface mechanisms. Therefore, various user interfaces can be provided to the consumer for interacting with the electronic wallet. Furthermore, because the consumer computing device 102 can be a portable consumer computing device, any form of electronic wallet user interface that can be implemented for portable computing device can be utilized.

Therefore, the electronic wallet, as well as payment methods in the electronic wallet, can be accessible to the consumer anywhere, as long as the consumer computing device 102 can connect to the data network 104.

For example, as the consumer enters various business establishments, clothing stores, restaurants, etc., the consumer can access his or her electronic wallet via the consumer computing device 102 and redeemed the coupons in the electronic wallet, etc. Therefore, such coupons can be at the fingertips of the consumer and can be redeemed more appropriately according to the location of the consumer, as well as be delivered to the consumer based on consumer location and preferences.

Furthermore, a wallet configuration allows for better categorization of coupons and ordering. In one example, a consumer can reorder the display of the coupons based on expiration date, location, etc. In another example, the consumer can for example add folders for specific types of coupons. The consumer can have a folder for restaurants, a separate folder for clothing stores, and a separate folder for music stores.

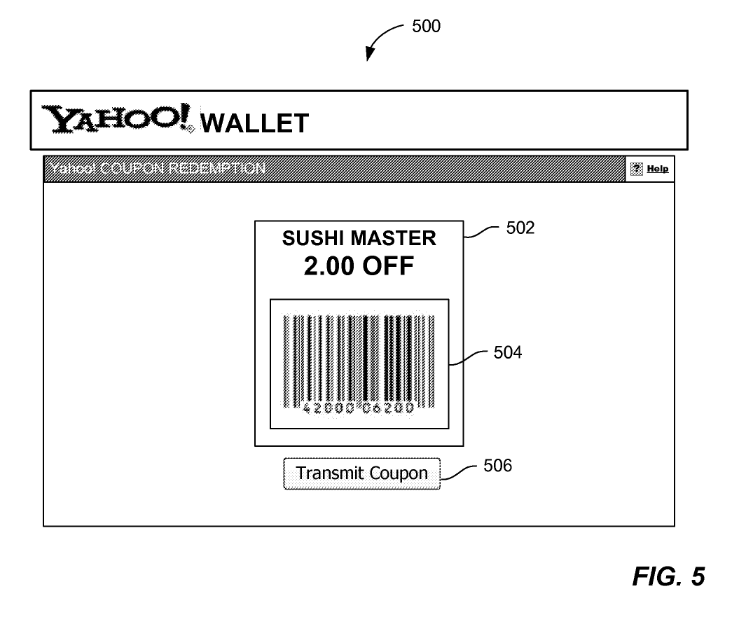

FIG. 5 depicts an exemplary user interface of a coupon stored in an electronic wallet of a consumer according to one embodiment. User interface 500 illustrates an electronic coupon that is displayed on a user interface of a consumer computing device 102. The consumer computing device 102 displays the coupon 502. In one example, the consumer computing device 102 receives the coupon for display from the subscription service 140 which stores the coupon in the consumer profile.

The coupon can be displayed on the consumer computing device 102 screen for redemption. As such, the consumer computing device 102 can further display the coupon 502 with a barcode 504. In one example, the barcode 504 can be another identifier such as a code or any other coupon identifier. Furthermore, the user interface 500 illustrates a button 506 that allows a consumer to transmit the coupon via infrared, Bluetooth, or any other wireless transmission method to the merchant computing device 106. Upon the consumer selecting the transmit coupon button 506, the coupon information corresponding to coupon 502 can then be submitted to the merchant computing device 106. The merchant computing device 506 can turn submit the coupon data to the coupon redemption module 110 for verification, redemption of the coupon and finalization of the transaction. Various other user interfaces can be used to represent a coupon, promotion, or offer stored in an electronic wallet of a consumer. Likewise, various other user interfaces mechanisms and methods can be utilized to redeem coupons or other promotional material delivered to an electronic wallet of a consumer as disclosed herein.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of distributing coupons to a consumer, comprising:
receiving a geographical location of the consumer;
identifying a set of merchants located within a predetermined distance from the geographical location so that the merchants in the set of merchants are located within the vicinity of the consumer;
identifying a coupon that can be redeemed for purchase of merchandise of one of the set of merchants; and
delivering the coupon to an electronic wallet of the consumer, the electronic wallet accessible by the consumer through a data network such that the consumer can apply the coupon to the purchase of the merchandise from the merchant.

2. The method of claim 1, further comprising submitting an alert indicator to a consumer computing device once the coupon is delivered to the consumer.

3. The method of claim 1, wherein the electronic wallet resides on a remote location on the data network.

4. The method of claim 1, wherein the geographical location is a longitude and latitude calculated by a ground positioning system.

5. The method of claim 1, wherein the coupon is applied towards the purchase the merchandise from the one of the set of merchants.

6. The method of claim 1, further comprising permitting the consumer to access the coupon in the electronic wallet over the computer network in order to redeem the coupon, the consumer accessing the coupon using a consumer computing device that communicates over the computer network with the service provider.

7. The method of claim 1, further comprising permitting the consumer to view the coupon in the electronic wallet in order to redeem the coupon.

8. The method of claim 1, further comprising receiving a redemption request from the merchant upon the consumer providing the coupon to the merchant.

9. The method of claim 8, further comprising validating the coupon upon receiving the redemption request.

10. The method of claim 1, further comprising searching for coupons according to consumer preferences.

11. A system of distributing coupons to a consumer, comprising:
a search engine that identifies a set of merchants located within a predetermined distance from a geographical location so that the merchants in the set of merchants are located within the vicinity of the consumer, the search engine configured to identify a coupon that can be redeemed for purchase of merchandise of one of the set of merchants; and
a coupon delivery module that delivers the coupon to an electronic wallet of the consumer, the electronic wallet accessible by the consumer through a data network such that the consumer can apply the coupon to the purchase of the merchandise from the merchant.

12. The system of claim 11, wherein an alert indicator is submitted to a consumer computing device once the coupon is delivered to the consumer.

13. The system of claim 11, wherein the electronic wallet resides on a remote location on the data network.

14. The system of claim 11, wherein the geographical location is a longitude and latitude calculated by a ground positioning system.

15. The system of claim 11, wherein the coupon is applied towards the purchase the merchandise from the one of the set of merchants.

16. The system of claim 11, further comprising a user interface configured to permit the consumer to access the coupon in the electronic wallet in order to redeem the coupon.

17. The system of claim 11, further comprising a user interface configured to permit the consumer to view the coupon in the electronic wallet in order to redeem the coupon.

18. The system of claim 11, further comprising a coupon redemption module configured to receive a redemption request from the merchant upon the consumer providing the coupon to the merchant.

19. The system of claim 14, wherein the coupon redemption module is further configured to validate the coupon upon receiving the redemption request.

20. The system of claim 11, wherein the search engine is further configured to search for coupons according to consumer preferences.
